(19) United States
(12) Patent Application Publication
(10) Pub. No.: US 2016/0018083 A1
(43) Pub. Date: Jan. 21, 2016

(54) CUSTOMIZABLE LIGHT-UP DEVICE

(71) Applicant: LightUpToys.com LLC, Sellersburg, IN (US)

(72) Inventors: Joshua Kelly, Sellersburg, IN (US); Max Armendariz Lalama, Georgetown, IN (US); Macaulay Bruton, Jeffersonville, IN (US); Christopher Kelly, New Albany, IN (US)

(21) Appl. No.: 14/684,479

(22) Filed: Apr. 13, 2015

Related U.S. Application Data
(63) Continuation-in-part of application No. 14/487,423, filed on Sep. 16, 2014.
Application No. 14/487,423 is a continuation-in-part of application No. 14/299,231, filed on Jun. 9, 2014.
(60) Provisional application No. 61/878,148, filed on Sep. 16, 2013.
(60) Provisional application No. 61/899,312, filed on Nov. 4, 2013.
(60) Provisional application No. 61/904,732, filed on Nov. 15, 2013.
(60) Provisional application No. 61/951,620, filed on Mar. 12, 2014.
(60) Provisional application No. 61/991,556, filed on May 11, 2014.
(60) Provisional application No. 61/822,917, filed on May 14, 2013.
(60) Provisional application No. 61/992,999, filed on May 14, 2014.
(60) Provisional application No. 62/104,792, filed on Jan. 18, 2015.

(51) Int. Cl. F21V 14/02; B62B 5/00; F21V 23/04; F21V 21/40; F21V 33/00; F21V 8/00

(52) U.S. Cl. CPC F21V 14/025; F21V 33/008; G02B 6/0096; F21V 33/0004; F21V 23/0414; F21V 21/406; F21V 23/0442; B62B 5/0003; F21Y 2101/02

(57) ABSTRACT

A customizable light-up device and electronic spinning novelty toy that can illuminate spinning elements that the user can assemble from interconnecting components, and can include other spinning lighted elements capable of producing visual patterns. The present embodiments of the invention are motorized toy(s) that light up a volume of space by employing at least one moving source of light, and allows for the user(s) to modify the patterns of illumination by a method comprising (among other steps) adding, removing, and/or moving components that can be or are lighted and the user(s) can have the toy spin creating different visual patterns of light.

### CROSS-REFERENCE TO RELATED APPLICATIONS

This application is a continuation in part of U.S. Nonprovisional application Ser. No. 14/487,423, filed Sep. 16, 2014, which is a continuation in part of U.S. Nonprovisional application Ser. No. 14/299,231, filed Jun. 9, 2014. U.S. Nonprovisional application Ser. No. 14/487,423 claims the benefit of U.S. Provisional Application No. 61/878,148, filed Sep. 16, 2013; claims the benefit of U.S. Provisional Application No. 61/899,312, filed Nov. 4, 2013; claims the benefit of U.S. Provisional Application No. 61/904,732, filed Nov. 15, 2013; claims the benefit of U.S. Provisional Application No. 61/951,620, filed Mar. 12, 2014; and claims the benefit of U.S. Provisional Application No. 61/991,556, filed May 11, 2014. U.S. Nonprovisional application Ser. No. 14/299,231 claims the benefit of U.S. Provisional Application No. 61/822,917, filed May 14, 2013.

In addition, this application claims the benefit of U.S. Provisional Application No. 61/992,999, filed May 14, 2014, and U.S. Provisional Application No. 62/104,792, filed Jan. 18, 2015.

### BACKGROUND OF THE INVENTION

1. Field of the Invention

The present invention is a customizable light-up device in the field of toys with lights. More particularly, the present embodiments of the invention are motorized toys that light up a volume of space by employing at least one moving source of light, and allow the user(s) to modify the patterns of illumination through a method comprising adding, removing, and/or moving components of the invention that may be or are illuminated, among other steps.

2. Description of the Prior Art

For many years there have been toys that illuminate objects, from simple flashlights to projectors of static and moving images. There are also scanning toys that create arcs of light resulting from moving sources of light.

The present invention enables the user to add or subtract elements that can be illuminated, thus enabling one to build a customizable toy with light. This produces a unique effect that can appeal to a market driven by the marriage of technology and entertainment.

### SUMMARY OF THE INVENTION

The customizable light-up device invention enables a person to assemble a light up and spinning toy with different light transmission and light radiating elements. The present invention has various embodiments, some of which are known as a “BUILD A SPINNER” or “CREATE A LIGHT”. In one embodiment the invention is a hand held spinning toy comprising of the following: a hand-held base unit housing, at least one switch or button, at least one power source, at least one of circuitry, wiring, a motorized sub-system having: an assembly spinning about a central axis, at least one LED, at least one release coupling mechanism capable of at least one of transmitting light, making at least one electrical connection, and at least one extension element capable of attaching to at least one release coupling mechanism via at least one release coupling mate. At least one extension element can be a flexible extension element or a rigid extension element.

At least one extension element can be at least one of: at least one release coupling mate located on at least one first end of at least one length of light pipe and at least one terminating element located on at least one second end of at least one length of light pipe; at least one release coupling mate located on at least one first end of at least one length of light pipe and at least one second release coupling mechanism located on at least one second end of at least one length of light pipe; at least one release coupling mate located on at least one first end of at least one length of light pipe and at least one second release coupling mate located on at least one second end of at least one length of light pipe; at least one other release coupling mate connected to and in intimate optical interface with at least one other terminating element; at least one other release coupling mate connected to and in intimate optical interface with at least one central terminating element and at least one release coupling mechanism connected to and in intimate optical interface with at least one central terminating element.

At least one of at least one release coupling mate, other release coupling mate, at least one second release coupling mechanism can be capable of transmitting light. At least one length of light pipe can transmit light from at least one first end of at least one length of light pipe to at least one second end of at least one length of light pipe. At least one length of light pipe can radiate light from at least one portion of at least one length of light pipe. At least one terminating element and/or at least one other terminating element is capable of radiating light. At least one of at least one terminating element, and/or at least one other terminating element can be at least one of a commonly recognizable shape including but not limited to at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, plant, rock, formation, body part, machine. The extension element can extend to a greater radius from the central axis. At least one extension element can contain at least one of wires, at least one release coupling mate capable of making at least one electrical connection, at least one second release coupling mechanism capable of making at least one electrical connection, at least one terminating element, at least one other terminating element, at least one LED. At least one length of light pipe can be at least one length of fiber optic material. At least one extension element can be a plurality of extension elements that are at least one of having the ability to interconnect to one another, having the ability to connect to at least one location on the assembly spinning about a central axis that possess at least one release coupling mechanism, having the ability to connect to at least one location on at least one terminating element, having the ability to connect to at least one location on at least one other terminating element, having the ability to connect to at least one location on at least one central terminating element. At least one extension element can further comprise at least one of a diffuser or diffusing material, frosted section, reflective material, roughed surface, translucent section, different density material.

The invention can further comprise of slip rings. At least one switch or button can be an on/off switch or button. At least one switch or button can be a mode control switch or button. The mode control switch or button can change at least one pattern of illumination. At least one pattern of illumination can be at least one of at least one multiplicity of at least one pattern of illumination, a constant static color, at least one color that fades from at least one color to at least one other color, at least one color that abruptly changes from at least one color to at least one other color, multi-color, at least one blinking pattern, at least one dimming pattern.

The hand-held base unit housing can contain at least one LED. The assembly spinning about a central axis can further comprise at least one shape capable of at least one of radiating light, transmitting light, being illuminated by light. At least one shape capable of at least one of radiating light, transmitting light, being illuminated by light can be at least one three dimensional shape. The three dimensional shape can be at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, plant, rock, formation, body part, machine. At least one LED can be at least one multi-color LED, red LED, green LED, blue LED, yellow LED, purple LED, white LED, IR LED, UV LED.

The invention can further comprise of at least one additional LED. At least one additional LED can illuminate at least one other shape capable of at least one of transmitting light, reflecting light, and/or being illuminated by light.

At least one power source can be at least one battery. The hand-held base unit housing can have a hand grip molded into the housing. The invention can further comprise of a means to create at least one sound. The invention can further comprise at least one of an additional switch, sensor, sensing element. At least one of an additional switch, sensor, sensing element can provide at least one signal with each rotation or part thereof of the assembly spinning about a central axis relative to the housing. At least one sound can be synchronized with at least one signal. At least one pattern of illumination can be synchronized with at least one signal. At least one sound can be synchronized with at least one pattern of illumination.

The invention can further comprise a communication device that receives data or signals via at least one of RF, IR, acoustically, or other methods. The data or signals can control at least one pattern of illumination or at least one sound or at least one pattern of illumination and at least one sound. The invention can further comprise RFID technology or proximity sensing devices that will produce a proximity signal to indicate proximity to at least one object and location or object or location. At least one custom sound and at least one pattern of illumination or at least one custom sound or at least one pattern of illumination can indicate proximity to at least one object and location or object or location.

The invention can further comprising of a removable base. At least one light can be in the hand-held base unit housing. The hand-held base unit housing can contains at least one lens. There can be a projection out of the bottom or side or bottom and side of the hand-held base unit housing. The invention can further comprising at least one of a logo, image, three dimensional object in said housing. At least one of a logo, image, three dimensional object can be illuminated. The hand-held base unit housing can contain at least one logo or character or character and logo printing on the inside.

The customizable light-up device is comprised of at least one of the following: a base unit housing; at least one hand holding area, section, and/or grip; at least one switch or button; at least one power source; at least one of circuitry, wiring; at least one stand that can be removable attached (can also look like and/or act like limbs or legs); and/or at least one motorized sub-system having at least one of the following: an assembly spinning about a central axis; at least one LED; at least one release coupling mechanism capable of at least one of transmitting light, making at least one electrical connection; and/or at least one extension element capable of attaching to said at least one release coupling mechanism via at least one release coupling mate. The at least one extension element may be a flexible extension element or a rigid extension element. The at least one extension element may be at least one of: at least one release coupling mate located on at least one first end of at least one length of light pipe and at least one terminating element located on at least one second end of said at least one length of light pipe and/or The at least one release coupling mate located on at least one first end of at least one length of light pipe and at least one second release coupling mechanism located on said at least one second end of said at least one length of light pipe; and/or the at least one release coupling mate located on at least one first end of at least one length of light pipe and at least one second release coupling mate located on said at least one second end of said at least one length of light pipe; and/or the at least one other release coupling mate connected to and in intimate optical interface with at least one other terminating element; and/or the at least one other release coupling mate connected to and in intimate optical interface with at least one central terminating element and at least one release coupling mechanism connected to and in intimate optical interface with at least one said central terminating element. The customizable light-up device may have at least one of the following: that the said at least one of at least one release coupling mate, other release coupling mate, at least one second release coupling mechanism if present are capable of transmitting light; said at least one length of light pipe transmits light from said at least one first end of at least one length of light pipe to said at least one second end of said at least one length of light pipe; at least one of the said at least one terminating element, said at least one other terminating element if present may be capable of radiating light; said at least one length of light pipe if present is at least one length of fiber optic material; said at least one extension element if present is a plurality of extension elements that are at least one of having the ability to interconnect to one another, having the ability to connect to at least one location on said assembly spinning about a central axis that possess at least one release coupling mechanism, having the ability to connect to at least one location on at least one terminating element, having the ability to connect to at least one location on at least one other terminating element, having the ability to connect to at least one location on at least one central terminating element; and/or said at least one extension element if present further comprises at least one of a diffuser or diffusing material, frosted section, reflective material, roughed surface, translucent section, different density material. The said at least one length of light pipe if present may radiate light from at least one portion of said at least one length of light pipe. Said at least one of said at least one terminating element, said at least one other terminating element if present may be at least one of a commonly recognizable shape including but not limited to at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, bug, plant, rock, rock formation, body part, machine, vehicle, boat, alien, wand, sword, knife, gun, pistol, boat, submarine, toy sword, toy vehicle, toy gun, toy, toy shield, toy wand, doll, toy figure, figurine, toy and/or airplane, helicopter, rocket.

The customizable light-up device may be at least one of a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), consumer product, and/or shape(s) including but not limited to: a character, caricature, celebrity or person's shape or image in whole or part, logo, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, remote controlled vehicle, remote controlled airplane, remote control toy, remote controlled helicopter, remote controlled rocket, and/or remote controlled quad copter, hand held toy(s), construction toy(s), toy block(s), pet(s), accessories, apparel, footwear, hair accessories, jewelry, fashion accessories, sports balls and equipment, bike accessories, bike spokes, costumes, headwear, skateboard accessories, wheels, wheel accessories, vehicle accessories, skateboard wheels, snowboard, yo-yo, spinning top, fan, Frisbee, nightstand, nightlight, electronic device, radio, clock radio, mobile phone accessory, and/or desktop device.

The customizable light-up device may include at least one of the following: said extension element extends to a greater radius from said central axis; and/or said at least one extension element contains at least one of wires, at least one release coupling mate capable of making at least one electrical connection, at least one second release coupling mechanism capable of making at least one electrical connection, at least one terminating element, at least one other terminating element, at least one LED.

The customizable light-up device may be further comprising at least one of: slip rings; at least one additional LED; a means to create at least one sound; a removable base; at least one light in said hand-held base unit housing; and/or at least one of a logo, image, three dimensional object in said housing.

The customizable light-up device may comprise at least one of the following: said at least one switch or button is an on/off switch or button; said at least one switch or button is a mode control switch or button; said hand-held base unit housing contains at least one LED; said assembly spinning about a central axis further comprises at least one shape capable of at least one of radiating light, transmitting light, being illuminated by light; said at least one LED is at least one multi-color LED, red LED, green LED, blue LED, yellow LED, purple LED, white LED, IR LED, UV LED; said at least one power source is at least one battery; said hand-held base unit housing has a hand grip molded into said housing; said hand-held base unit housing contains at least one lens; and/or said hand-held base unit housing contains at least one logo or character or character and logo printing on the inside.

The customizable light-up device may additionally comprise at least one of the following if present in the device: said mode control switch or button changes at least one pattern of illumination; said at least one pattern of illumination is at least one of at least one multiplicity of at least one pattern of illumination, a constant static color, at least one color that fades from at least one color to at least one other color, at least one color that abruptly changes from at least one color to at least one other color, multi-color, at least one blinking pattern, at least one dimming pattern; and/or said at least one shape capable of at least one of radiating light, transmitting light, being illuminated by light is at least one three dimensional shape.

The customizable light-up device wherein said three dimensional shape may be at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, bug, alien, boat, vehicle, submarine, plant, rock, rock formation, body part, machine, wand, sword, shield, knife, gun, pistol, toy sword, toy vehicle, toy gun, toy, toy shield, toy wand, doll, toy figure, figurine, vehicle, airplane, helicopter, rocket, quad copter, celebrity or person's shape or image in whole or part, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, jewelry, sports balls and equipment, wheels, wheel accessories, vehicle accessories, skateboard wheels, snowboard, yo-yo, spinning top, fan, Frisbee.

The customizable light-up device wherein said three dimensional shape may be at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, bug, alien, boat, vehicle, submarine, plant, rock, rock formation, body part, machine, wand, sword, shield, knife, gun, pistol, toy sword, toy vehicle, toy gun, toy, toy shield, toy wand, doll, toy figure, figurine, vehicle, airplane, helicopter, rocket, quad copter, celebrity or person's shape or image in whole or part, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, jewelry, sports balls and equipment, wheels, wheel accessories, vehicle accessories, skateboard wheels, snowboard, yo-yo, spinning top, fan, Frisbee.

The customizable light-up device might have at least one additional LED illuminates at least one other shape capable of at least one of transmitting light, reflecting light, being illuminated by light.

The customizable light-up device may further comprise at least one of an additional switch, sensor, sensing element.

The customizable light-up device may additional include wherein at least one of an additional switch, sensor, sensing element provides at least one signal with each rotation or part thereof of said assembly spinning about a central axis relative to said housing.

The customizable light-up device wherein at least one sound may synchronized with said at least one signal.

The customizable light-up device may have at least one pattern of illumination is synchronized with said at least one signal.

The customizable light-up device wherein said at least one sound might synchronized with said at least one pattern of illumination.

The customizable light-up device further might comprise a communication device that receives data or signals via at least one of RF, IR, acoustically, or other methods such as for example the following: GPS, Wi-Fi, satellite, radio wave, Bluetooth, RFID, sonar, sonic, audio, vibration, light, sound, electronic, UHF, microwave, broad band modulation, amplitude modulation, frequency modulation, spread spectrum, and/or infrared.

The customizable light-up device wherein said data or signals controls said at least one pattern of illumination or at least one sound or said at least one pattern of illumination and said at least one sound. Also can control other functions such as vibration or others.

The customizable light-up device may comprises RFID technology or proximity sensing devices that will produce a proximity signal to indicate proximity to at least one object and location or object or location.

The customizable light-up device may include wherein at least one custom sound and at least one pattern of illumination or at least one custom sound or at least one pattern of illumination indicates proximity to at least one object and location or object or location.

The customizable light-up device may have a projection device and a projection out of the bottom, top or side or any combination of bottom, top, and/or side of said hand-held base unit housing.

The customizable light-up device wherein at least one of a logo, image, three dimensional or other object or shape may be illuminated.

The device may have at least one battery.

The device may have at least one battery housed within at least one battery compartment.

The device wherein at least one switch or button may comprised of at least one on/off switch.

The device my further comprise at least one of the following: at least one locating and/or sensing mechanism; at least one receiver; at least one controller; at least one transmitter; at least one transmitter/receiver; and/or a controlling and/or operating software application utilized to control or operate at least one of at least one receiver, at least one controller, at least one transmitter, and/or at least one transmitter/receiver.

The device wherein at least one of the at least one locating and/or sensing mechanism, at least one receiver, and/or at least one controller, at least one transmitter, and/or at least one transmitter/receiver can receive and/or transmit at least one of GPS, Wi-Fi, satellite, radio wave, Bluetooth, RFID, sonar, sonic, audio, vibration, light, sound, electronic, UHF, microwave, broad band modulation, amplitude modulation, frequency modulation, spread spectrum, and/or infrared.

The device wherein at least one of the at least one receiver, at least one transmitter and/or at least one transmitter/receiver is attached and/or connected to, and/or partially or wholly located within or inside the at least one locating and/or sensing mechanism and/or is the at least one locating and/or sensing mechanism.

The device wherein at least one of the at least one receiver, at least one transmitter and/or at least one transmitter/receiver may be located within or may attached to the at least one controller.

The device may have at least one controller as at least one remote control.

The device wherein the at least one controller may be at least one of a computer, input device, output device, tablet, smart phone, smart device, sound device, and/or a stationary, handheld, and/or mobile device.

The device wherein the at least one remote control may further comprise at least one button or other signal controller that, when depressed, initiated, and/or activated, sends or receives at least one signal to or from at least one of the at least one receiver, at least one transmitter, and/or at least one transmitter/receiver located in the at least one remote control to at least one of the at least one receiver, at least one transmitter, and/or at least one transmitter/receiver located in the at least one locating and/or sensing mechanism.

The device wherein it might further include that the at least one controlling and/or operating software application, when activated and/or instructed to, sends at least one signal from at least one of the at least one transmitter and/or at least one transmitter/receiver located in the at least one controller to at least one of the at least one locating and/or sensing mechanism and/or the at least one receiver and/or at least one transmitter/receiver located in/on the at least one locating and/or sensing mechanism.

The device might further comprise a means for making noise and/or sound, audio, music, voice, songs, creating light and/or flashing lights, vibrating, and/or creating any other celebration display on and/or from said device.

The device may further comprise at least one strap or other carrying device.

The device might be a remote controlled toy.

The device might be able to be programmed to perform certain functions by inputting or entering instructions.

The device might have at least one switch or button or sensor or sensing element might be at least one of sensed by, connected to, activated by, deactivated by, and/or controlled by electronics.

The device whereby at least one switch and/or at least one sensor might be activated by at least one of motion, acceleration and/or impact.

The device further might comprise electronics that are able to control the lighting of said at least one LED light in at least one lighting sequence.

The device whereby the activation of at least one switch and/or at least one sensor can possibly initiate, activate, deactivate, control, operate, and/or run at least one lighting sequence.

The device might include whereby the lighting of an at least one lighting sequence can be at least one of repetitive or random.

The lighting, circuitry and/or electronics may incorporate a dimming function as part of said at least one lighting sequence.

At least one switch and/or at least one sensor may sense sound, vibration, acoustic energy and/or audio from the environment and convert such sound, vibration, acoustic energy and/or audio into a signal.

The device if with at least one signal said signal may be resolved into frequency, amplitude and/or a combination thereof and said frequency, amplitude and/or a combination thereof may control or affect the pattern and/or intensity of the LED lighting.

The device may additionally comprise at least one of a connector and/or jack for connecting the device to an audio, power and/or other source.

The device may further comprising a conductive connector or jack for connecting the device to a mobile device, smart device, computer, electronic device, tablet, reader, mobile phone, and/or other device or signal source.

The device may further comprise of at least one custom color and/or pattern, sound, audio, vibration, light, voice, music, song, or other recognition feature for identification for calls, e-mails, texts, and/or other origin-specific electronic communications, and/or at least one communication device that can transmit and/or receive data and/or signals in a master-slave fashion via radio frequency, infrared, and/or other communication methods.

The device may further comprise of at least one custom color and/or pattern, sound, audio, vibration, light, voice, music, song, or other recognition feature for identification for calls, e-mails, texts, and/or other origin-specific electronic communications, and/or at least one communication device that can transmit and/or receive data and/or signals in a master-slave fashion via radio frequency, infrared, and/or other communication methods.

The invention may include a customizable light-up device carry sales cart or push cart comprising of at least one of the following: at least one carrying or push cart used to carry products for sale commonly found at theme parks, amusement parks, and other outdoor parks, places, tourist attractions, sports events, arenas, and events; at least one power source; at least one tray surface or at least two tray surfaces (bottom and top); at least one display rack for toys or other products to be placed for marketing, demonstration, and sale; at least one display rack designed for light-up toys or other products to be placed for marketing, demonstration, and sale; at least one display rack designed for light-up toys or other products to be placed for marketing, demonstration, and sale with special holographic and reflective surface for better viewing of a light up toy such as the customizable light-up device; at least one attaching device for display rack to cart; at least one mounting and holding device or attachment to hold in place toys or products; at least one remote control unit capable of controlling at least one toy or product for demonstration while such toy or product is displayed on the cart. The invention may additionally comprise a leg assembly.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGS. 1-9 illustrate various views of a handheld spinning toy embodiment of the present invention.

FIG. 10 illustrates a handheld spinning toy embodiment of the present invention with a leg and/or stand assembly.

FIG. 11 illustrates a handheld spinning toy embodiment of the present invention with a projection device.

FIG. 12 illustrates a handheld spinning toy sword embodiment of the present invention.

FIG. 13 illustrates a handheld light-up spinning toy gun embodiment of the present invention.

FIG. 14 illustrates a ball embodiment of the present invention.

FIG. 15 illustrates a yo-yo embodiment of the present invention.

FIG. 16 illustrates a diabolo embodiment of the present invention.

FIG. 17 illustrates a fashion accessory embodiment of the present invention, including wrist wear and neckwear embodiments.

FIG. 18 illustrates a hair accessory embodiment of the present invention.

FIG. 19 illustrates a side view of a display rack and customizable light-up device sales cart.

### DETAILED DESCRIPTION OF THE DRAWINGS

Detailed descriptions of particular embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

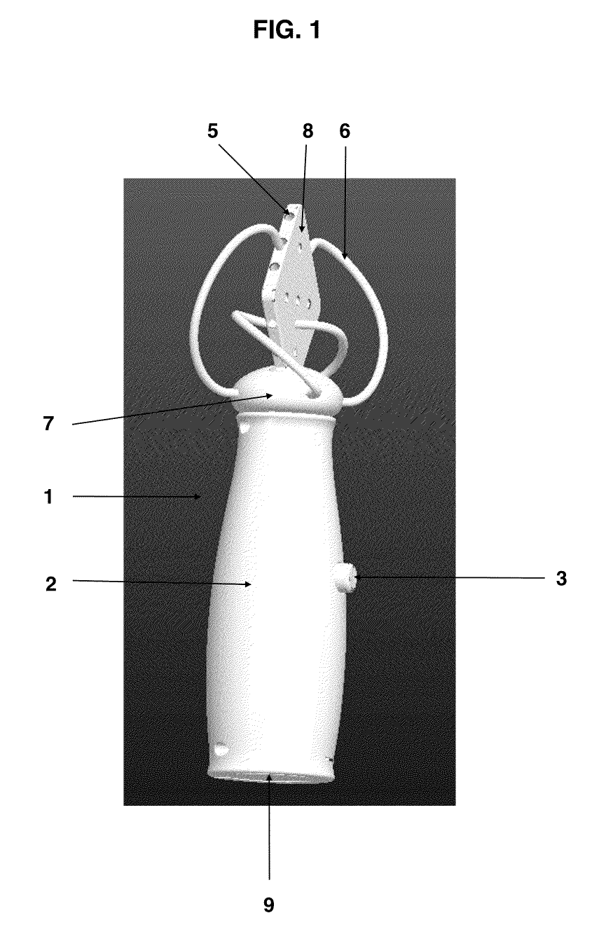

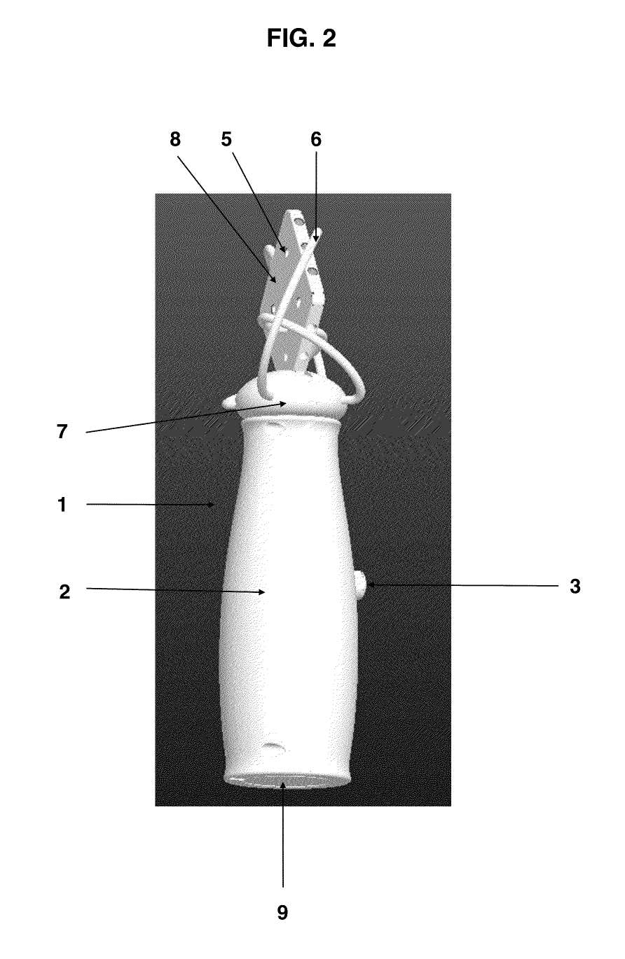

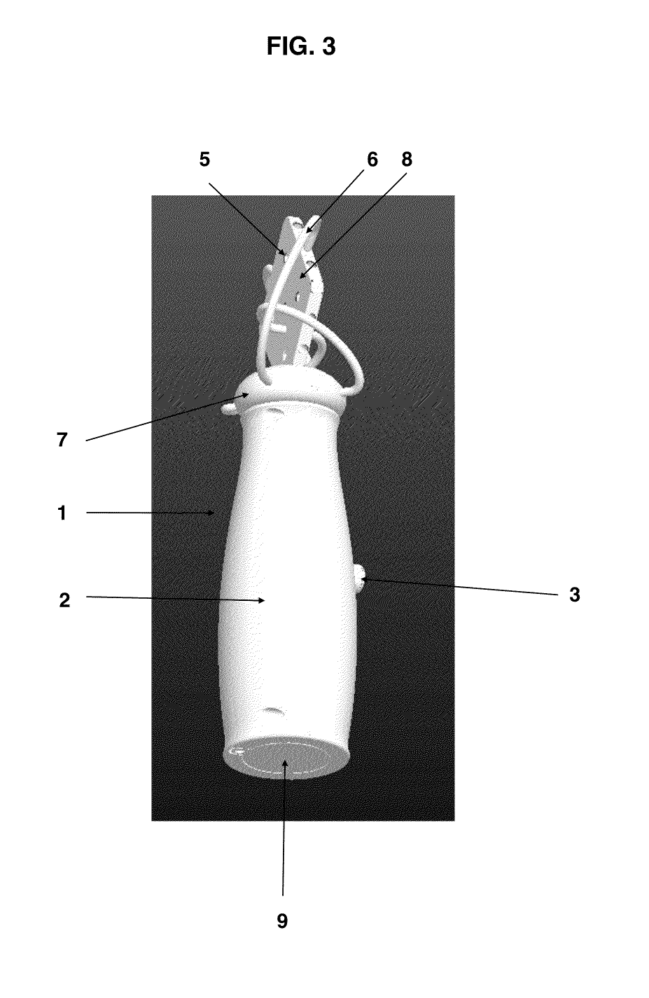

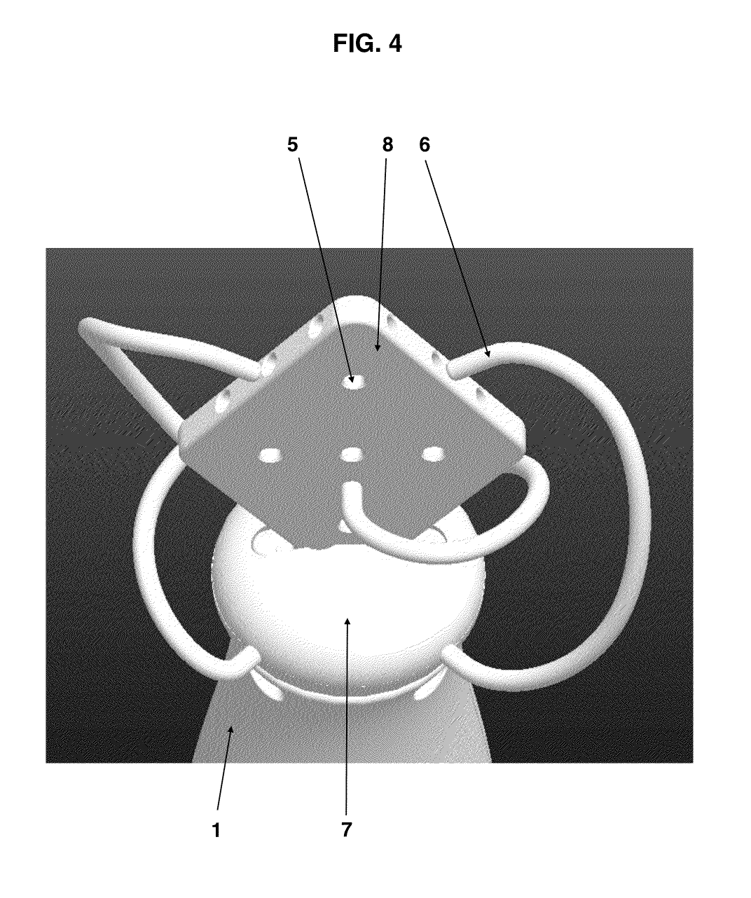

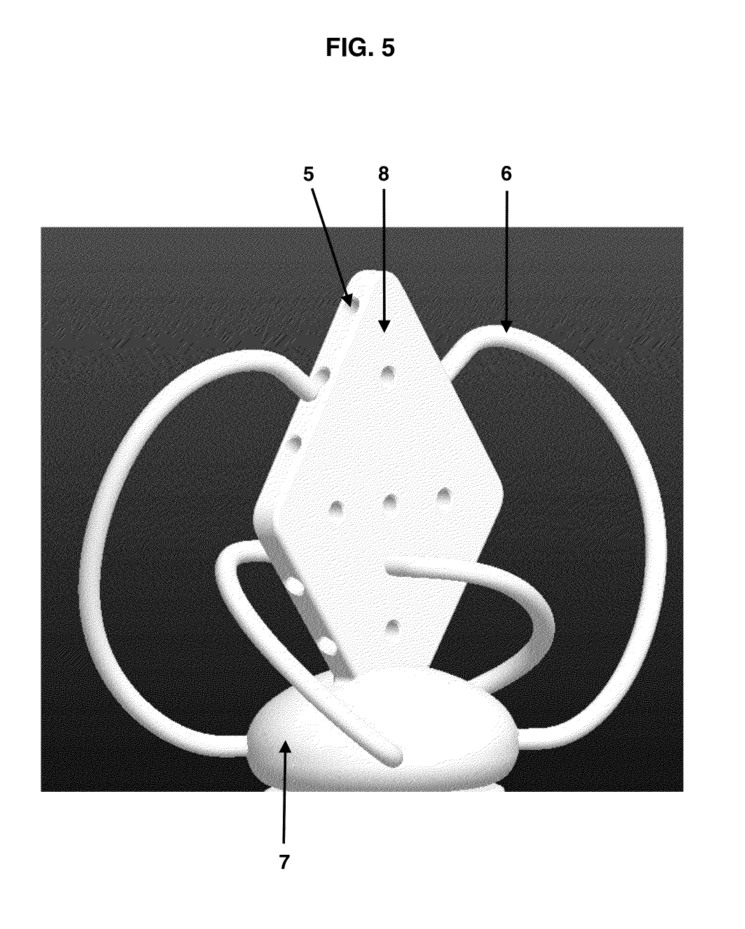

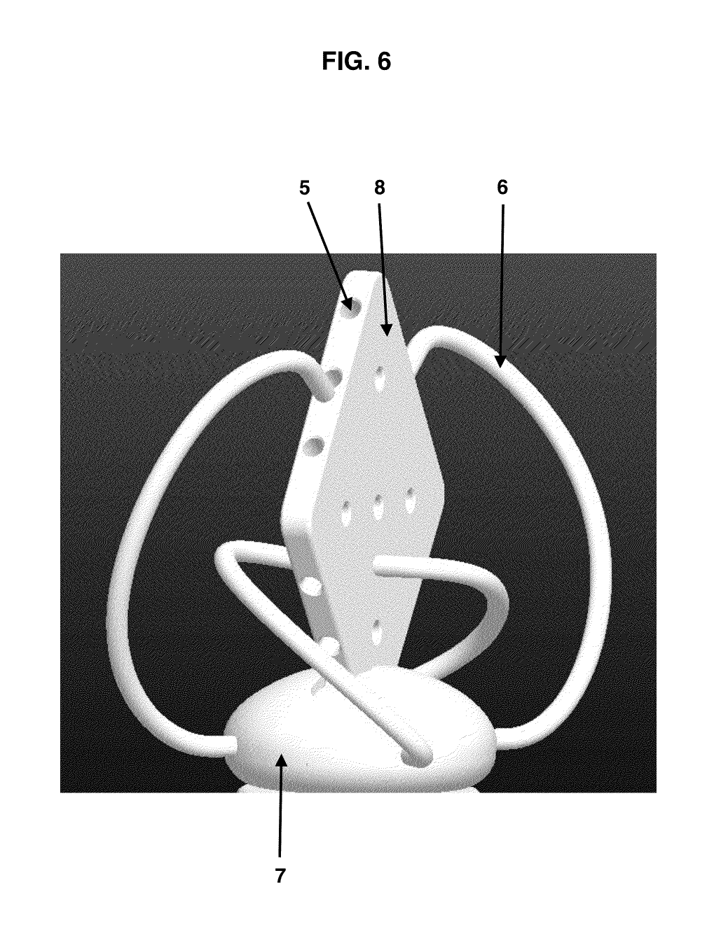

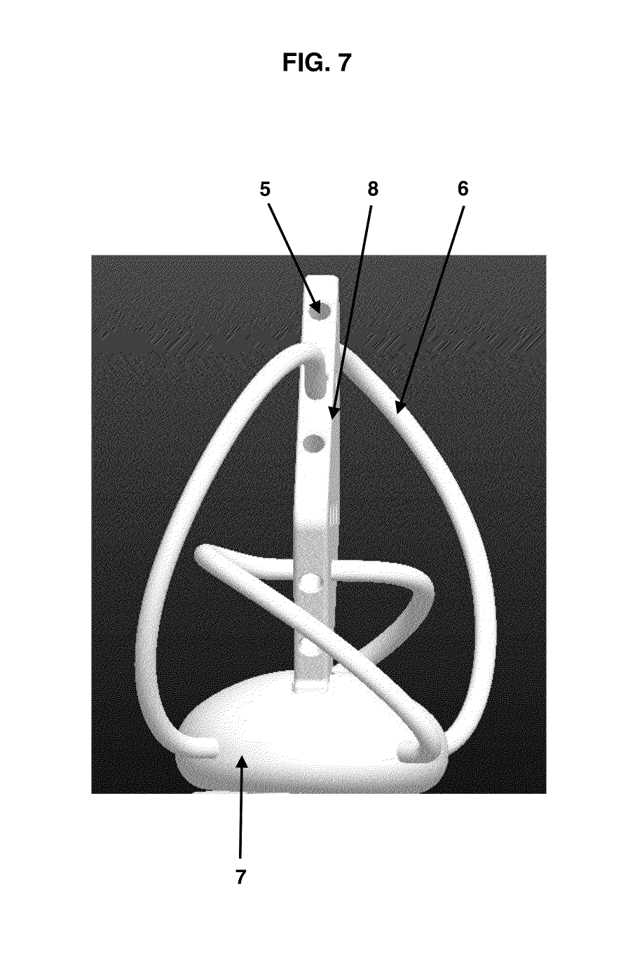

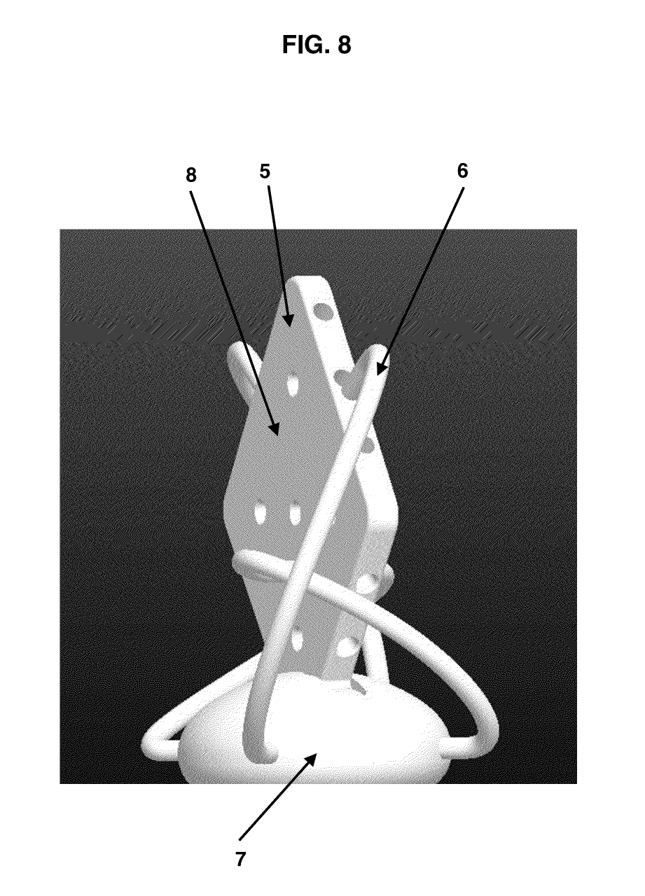

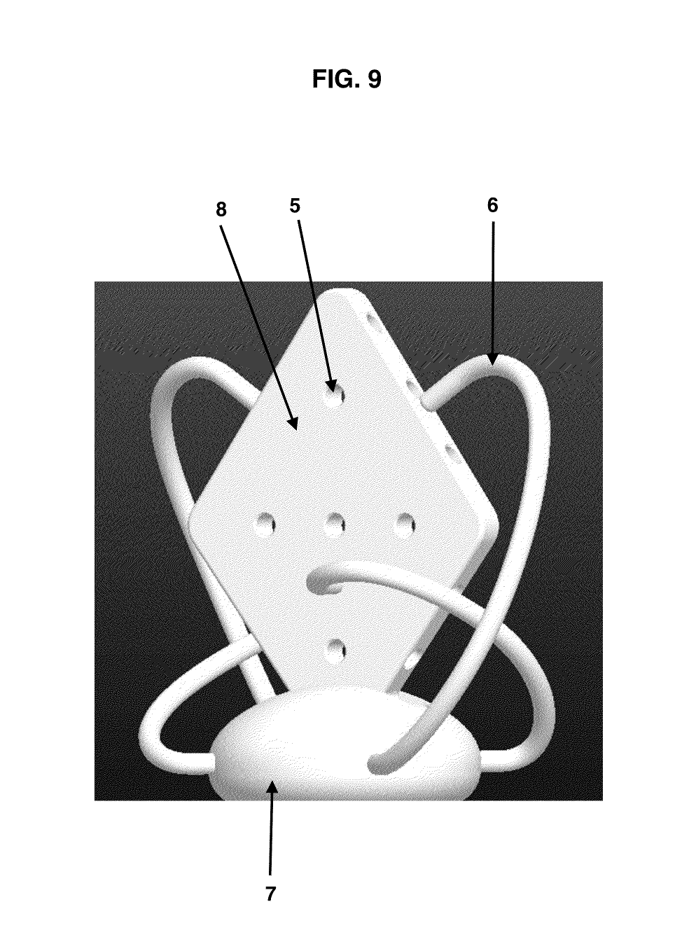

FIGS. 1-9 illustrate various views of a handheld spinning toy embodiment of the present invention with FIGS. 1-3 detailing a view of the entire handheld spinning toy embodiment of the present invention, and FIGS. 4-9 focusing on the upper portion of the handheld spinning toy embodiment of the present invention. A user holds the device via a grip 2 located on the base housing unit 1. Also located on the base housing unit 1 is an on/off switch, which, when activated or deactivated, closes or opens the circuitry (not shown) located within said base housing unit 1. The circuitry (not shown) located within the base housing unit 1 connects the on/off switch 3, the power source located in the battery compartment 9, and other components, including a sub-system (not shown), and LED light(s) (not shown), to one another. An assembly 7, which is motorized in this embodiment, that is part of the sub-system (not shown) spins around an axis located within the base housing unit 1, and holds LED light(s) (not shown). Attached to the assembly 7 is a shape that is capable of radiating or transmitting light, or being illuminated. In this embodiment, the shape attached to the assembly 7 is a diamond shape 8, but, as described further herein, the shape can take on many different forms. Located on both the assembly 7 and the diamond shape 8 are a number of release coupling mechanisms 5 that allow for the connection of an extension element(s) 6, which are capable of radiating or transmitting light, or being illuminated. In this embodiment, the release coupling mechanism 5 is a cavity that allows for an extension element 8 to be inserted and retained within said cavity via a release coupling mate (not shown). When the device is activated by a user pushing the on/off switch 3 into the on position, the circuitry (not shown) located within said base housing unit 1 is closed, and the power source located in the battery compartment 9 powers the sub-system (not shown,) which causes the assembly 7, the diamond shape 8, and any extension element(s) 6 attached to the assembly 7 and/or the diamond shape 8 to spin around the axis located in the base housing unit 1. Additionally, when the device is activated by a user pushing the on/off switch 3 into the on position, the LED light(s) located within the device become illuminated, and are visible to the user through the extension element(s) 6, and the diamond shape 8.

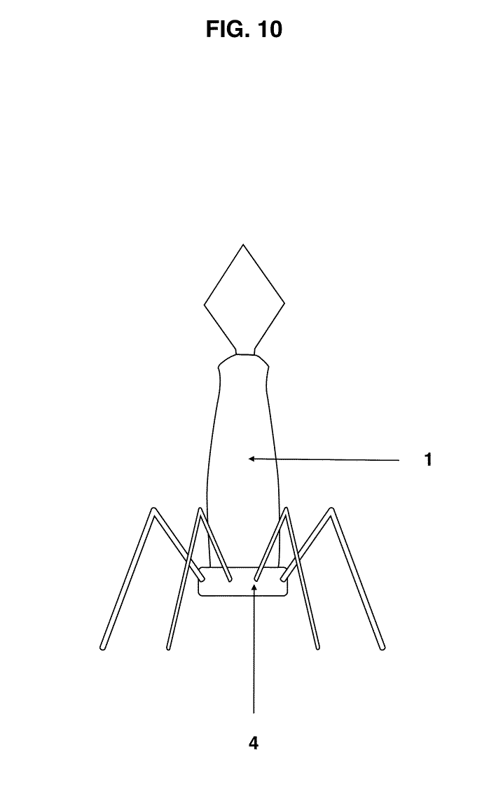

FIG. 10 illustrates the handheld spinning toy embodiment of the present invention depicted in FIGS. 1-9 with a leg and stand assembly 4 attached to the base unit housing 1 of the device.

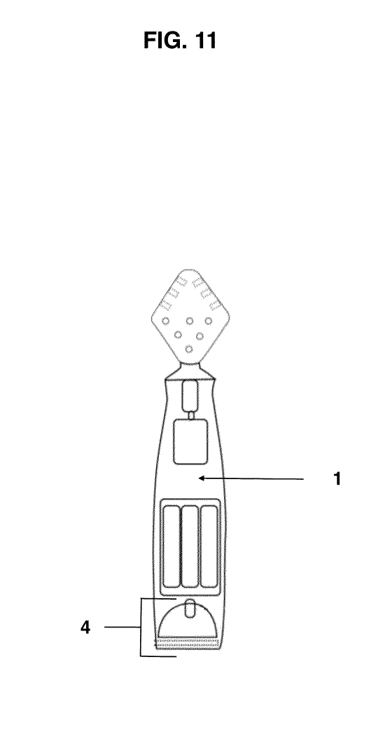

FIG. 11 illustrates the handheld spinning toy embodiment of the present invention depicted in FIGS. 1-9 with a projection device 10 in the bottom of the base unit housing 1.

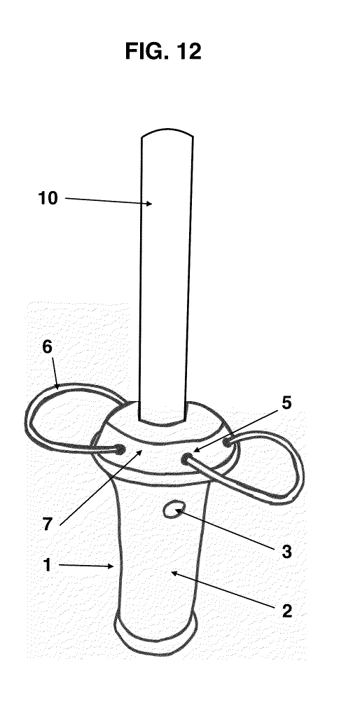

FIG. 12 illustrates a handheld spinning toy sword embodiment of the present invention, which is similar in most respects to the handheld spinning toy embodiment of the present invention described above and depicted in FIGS. 1-9 with one exception, namely the inclusion of a sword shape 8 in lieu of the diamond shape 8 depicted in FIGS. 1-9.

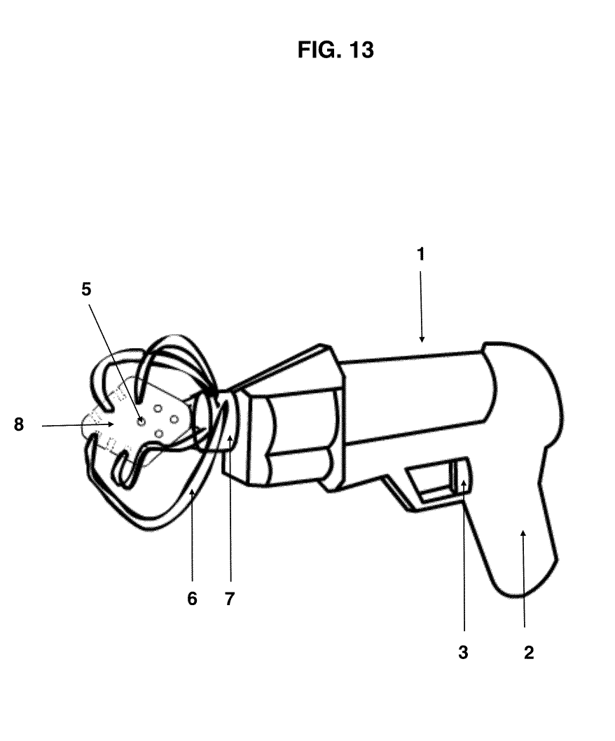

FIG. 13 illustrates a handheld light-up spinning toy gun embodiment of the present invention, which is similar in most respects to the handheld spinning toy embodiment of the present invention described above and depicted in FIGS. 1-9 with a number of exceptions, namely the shape of the base housing unit 1 in FIG. 13 is in the shape of a toy gun, the grip 2 is located on the handle of the toy gun, and the on/off switch 3 resembles the trigger of a toy gun.

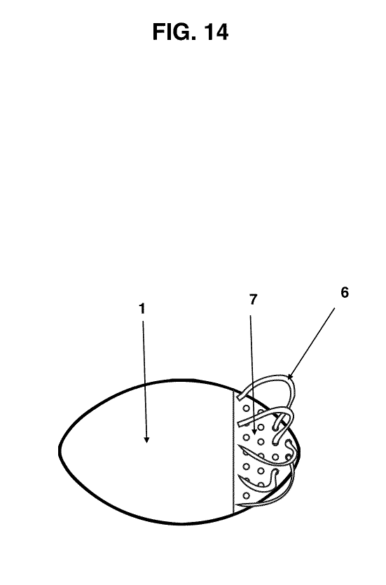

FIG. 14 illustrates a ball embodiment of the present invention where the base unit housing 1 and the assembly 7 are each in the shape of a semi-spheroid, such that a complete spheroid is formed when the base unit housing 1 and the assembly 7 are connected. When a user uses the ball embodiment of the present invention, the base unit housing 1, assembly 7, and any extension element(s) 6 attached thereto rotate and/or move in or opposite the direction in which the ball embodiment is moved.

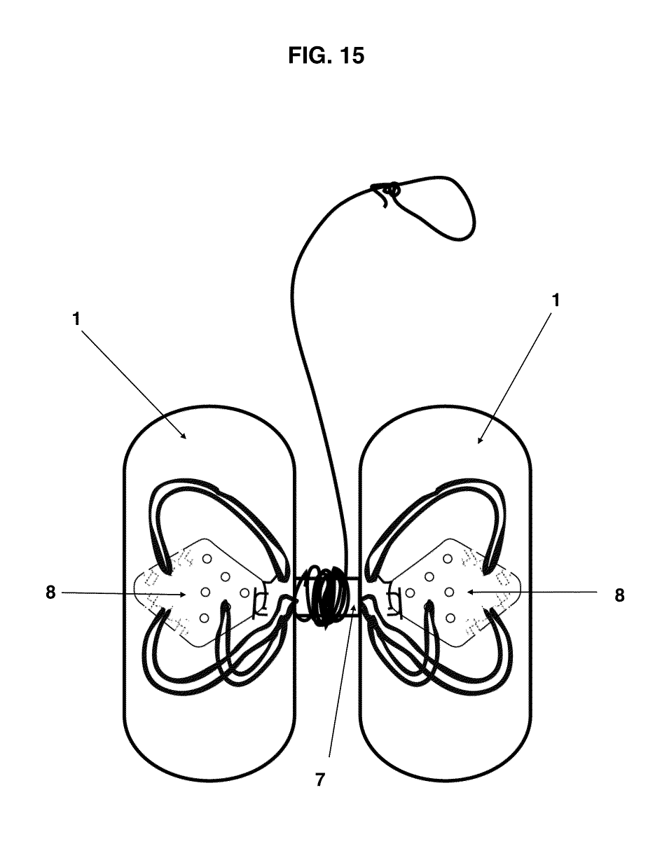

FIG. 15 illustrates a yo-yo embodiment of the present invention where there are two base unit housings 1, each of which are in the shape of a disk, and a diamond shape 8 for each of the two base unit housings 1. In this embodiment, one assembly 7 holds the two diamond shapes 8 and two base housing units 1.

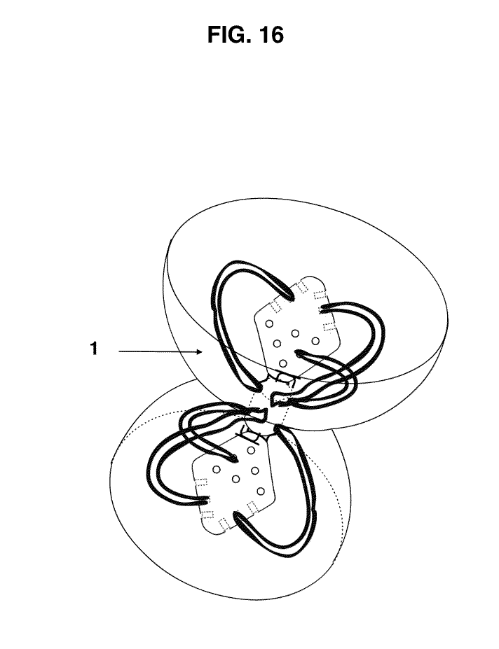

FIG. 16 illustrates a diabolo embodiment of the present invention, which is similar in most respects to the yo-yo embodiment of the present invention described above and depicted in FIG. 15 with the exception of the base housing unit 1 of the diabolo embodiment being more cylindrical in shape.

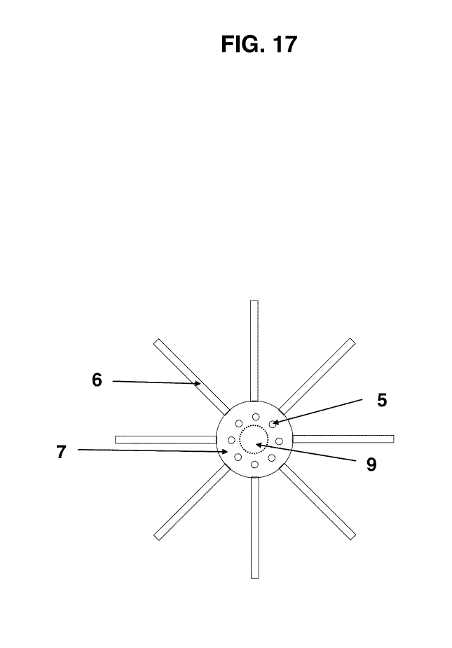

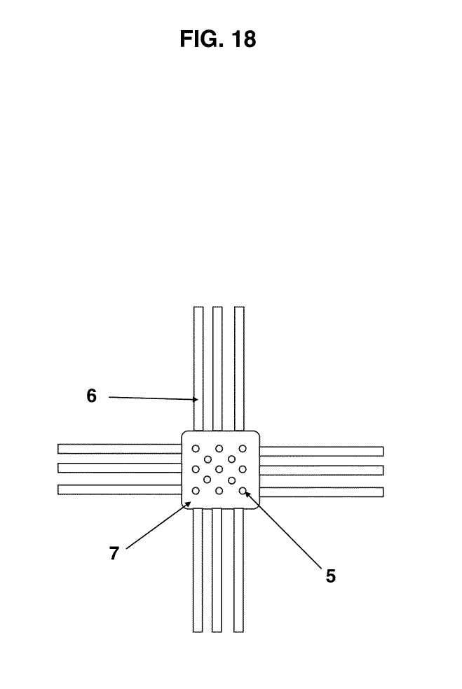

Other embodiments of the present invention include fashion accessories, such as the wrist or neckwear embodiment illustrated in FIG. 17, and the hairpiece embodiment illustrated in FIG. 18. In FIG. 17, the extension element(s) 6, assembly 7, and release coupling mechanism(s) 5 are created such that the connection of the extension element(s) 6 to the assembly 7 and/or release coupling mechanism(s) 5 can be worn around a user's wrist and/or neck. The embodiment in FIG. 17 also includes a battery compartment 9. In FIG. 18, the extension element(s) 6, assembly 7, and release coupling mechanism(s) 5 are created such that the connection of the extension element(s) 6 to the assembly 7 and/or release coupling mechanism(s) 5 can be worn in, connected, and/or attached to a user's hair.

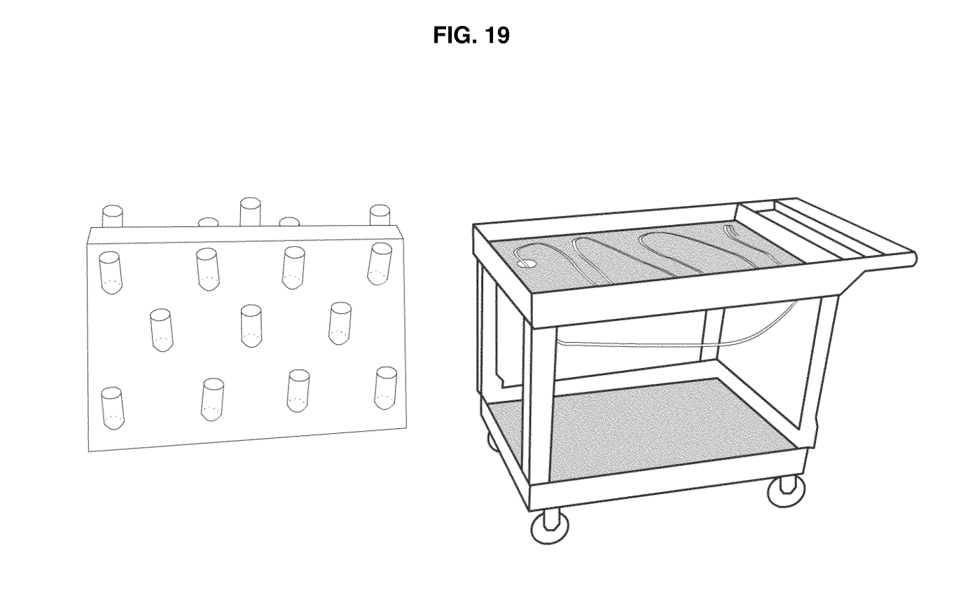

FIG. 19 illustrates a side view of a display rack and customizable light-up device sales cart.

### COMPONENT LIST FOR DRAWINGS

Following is a partial list of the components depicted in the drawings:

| Component No. | Component Description |
|---|---|
| 1 | Base Unit Housing |
| 2 | Grip |
| 3 | On/Off Switch |
| 4 | Leg and Stand Assembly |
| 5 | Release Coupling Mechanism |
| 6 | Extension Element |
| 7 | Assembly |
| 8 | Diamond Shape |
| 9 | Battery Compartment |
| 10 | Sword Shape |
| 11 | Projection Device |

### DEFINITIONS

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

What is claimed:

1. A customizable light-up device comprising of at least one of:
a base unit housing;
at least one hand holding area, section, and/or grip;
at least one switch and/or button;
at least one power source;
at least one of circuitry and/or wiring;
at least one removeably attachable leg, stand, leg assembly and/or stand assembly; and/or
at least one sub-system having at least one of:
an assembly;
an assembly spinning about a central axis;
a motorized assembly spinning about a central axis;
at least one LED;
at least one release coupling mechanism capable of at least one of transmitting light and/or making at least one electrical connection; and/or
at least one extension element capable of attaching to said at least one release coupling mechanism via at least one release coupling mate.

2. The device of claim 1 wherein said at least one extension element if present is a flexible extension element or a rigid extension element.

3. The device of claim 2 wherein said at least one extension element is at least one of:
at least one release coupling mate located on at least one first end of said at least one extension element and/or at least one length of light pipe and at least one terminating element located on at least one second end of said at least one extension element and/or said at least one length of light pipe;
at least one release coupling mate located on at least one first end of said at least one extension element and/or said at least one length of light pipe and at least one second release coupling mechanism located on said at least one second end of said at least one extension element and/or said at least one length of light pipe;
at least one release coupling mate located on at least one first end of said at least one extension element and/or said at least one length of light pipe and at least one second release coupling mate located on said at least one second end of said at least one extension element and/or said at least one length of light pipe;
at least one other release coupling mate connected to and in intimate optical interface with at least one other terminating element; and/or
at least one other release coupling mate connected to and in intimate optical interface with at least one central terminating element and at least one release coupling mechanism connected to and in intimate optical interface with at least one said central terminating element.

4. The device of claim 3 wherein at least one of the following:
said at least one of at least one release coupling mate, other release coupling mate, at least one second release coupling mechanism if present are capable of transmitting light;
said at least one extension element and/or at least one length of light pipe if present transmits light from said at least one first end of at least one extension element and/or at least one length of light pipe to said at least one second end of said at least one extension element and/or at least one length of light pipe;
at least one of said at least one terminating element, said at least one other terminating element is capable of radiating light;
said at least one extension element and/or at least one length of light pipe is at least one length of fiber optic material;
said at least one extension element is a plurality of extension elements that are at least one of having the ability to interconnect to one another, having the ability to connect to at least one location on said assembly spinning about a central axis that possess at least one release coupling mechanism, having the ability to connect to at least one location on at least one terminating element, having the ability to connect to at least one location on at least one other terminating element, having the ability to connect to at least one location on at least one central terminating element; and/or
said at least one extension element further comprises at least one of a diffuser or diffusing material, frosted section, reflective material, roughed surface, translucent section, different density material.

5. The device of claim 4 wherein said at least one extension element and/or at least one length of light pipe radiates light from at least one portion of said at least one extension element and/or at least one length of light pipe.

6. The device of claim 4 wherein said at least one of said at least one terminating element, said at least one other terminating element is at least one of a commonly recognizable shape including but not limited to at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a character, caricature, celebrity, logo, symbol, rocket, airplane, car, animal, bug, plant, rock, rock formation, body part, machine, vehicle, boat, alien, wand, sword, knife, gun, pistol, boat, submarine, toy sword, toy vehicle, toy gun, toy, toy shield, toy wand, doll, toy figure, figurine, toy, airplane, helicopter, and/or rocket.

7. The device of claim 1 is at least one of a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), consumer product, and/or shape(s) including but not limited to: a character, caricature, celebrity or person's shape or image in whole or part, logo, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, remote controlled vehicle, remote controlled airplane, remote control toy, remote controlled helicopter, remote controlled rocket, and/or remote controlled quad copter, hand held toy(s), construction toy(s), toy block(s), pet(s), accessories, apparel, footwear, hair accessories, jewelry, fashion accessories, sports balls and equipment, bike accessories, bike spokes, costumes, headwear, skateboard accessories, wheels, wheel accessories, vehicle accessories, skateboard wheels, snowboard, yo-yo, spinning top, fan, Frisbee, nightstand, nightlight, electronic device, radio, clock radio, mobile phone accessory, and/or desktop device.

8. The device of claim 1 wherein said at least one extension element extends to a greater radius from said central axis; and/or said at least one extension element contains at least one of wires, at least one release coupling mate capable of making at least one electrical connection, at least one second release coupling mechanism capable of making at least one electrical connection, at least one terminating element, at least one other terminating element, at least one LED.

9. The device of claim 1 further comprising at least one of:
slip rings;
at least one additional LED;
a means to create at least one sound;
a removable base;
at least one light in said base unit housing; and/or
at least one of a logo, image, three dimensional object in said housing.

10. The device of claim 1 wherein at least one of the following:
said at least one switch or button is an on/off switch or button;
said at least one switch or button is a mode control switch or button;
said base unit housing contains at least one LED;
said assembly spinning about a central axis further comprises at least one shape capable of at least one of radiating light, transmitting light, being illuminated by light;
said at least one LED is at least one multi-color LED, red LED, green LED, blue LED, yellow LED, purple LED, white LED, IR LED, UV LED;
said at least one power source is at least one battery;
said base unit housing has a hand grip molded into said housing;
said base unit housing contains at least one lens; and/or
said base unit housing contains at least one logo or character or character and logo printing on the inside.

11. The device of claim 10 wherein at least one of the following if present in the device:
said mode control switch or button changes at least one pattern of illumination;
said at least one pattern of illumination is at least one of at least one multiplicity of at least one pattern of illumination, a constant static color, at least one color that fades from at least one color to at least one other color, at least one color that abruptly changes from at least one color to at least one other color, multi-color, at least one blinking pattern, at least one dimming pattern; and/or
said at least one shape capable of at least one of radiating light, transmitting light, being illuminated by light is at least one three dimensional shape.

12. The device of claim 9 wherein said three dimensional object is at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, bug, alien, boat, vehicle, submarine, plant, rock, rock formation, body part, machine, wand, sword, shield, knife, gun, pistol, toy sword, toy vehicle, toy gun, toy, toy shield, toy wand, doll, toy figure, figurine, vehicle, airplane, helicopter, rocket, quad copter, celebrity or person's shape or image in whole or part, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, jewelry, sports balls and equipment, wheels, wheel accessories, vehicle accessories, skateboard wheels, snowboard, yo-yo, spinning top, fan, Frisbee.

13. The device of claim 10 wherein said shape is at least one of a star, crystal, sphere, rod, staff, blade, disk, device, wand, multi-sided, polyhedron, geometric shape, triangle, quadrilateral, pentagon, hexagon, septagon, octagon, polygon of any number of sides, a commonly recognizable shape including but not limited to a character, caricature, celebrity, logo, symbol, rocket, airplane, car, animal, bug, alien, boat, vehicle, submarine, plant, rock, rock formation, body part, machine, wand, sword, shield, knife, gun, pistol, toy sword, toy vehicle, toy gun, toy, toy shield, toy wand, doll, toy figure, figurine, vehicle, airplane, helicopter, rocket, quad copter, celebrity or person's shape or image in whole or part, symbol, rocket, airplane, car, animal, bug, plant, rock, rock formation, body part(s), machine, vehicle, boat, alien, wand, sword, knife, gun, pistol, boat, submarine, toy sword, toy vehicle, toy gun, toy, toy shield, toy wand, doll, toy figure, figurine, toy figurine, action figure, toy action figure, jewelry, sports balls and equipment, wheels, wheel accessories, vehicle accessories, skateboard wheels, snowboard, yo-yo, spinning top, fan, Frisbee.

14. The device of claim 9 wherein said at least one additional LED illuminates at least one other shape capable of at least one of transmitting light, reflecting light, being illuminated by light.

15. The device of claim 10 further comprising at least one of an additional switch, sensor, sensing element.

16. The device of claim 14 wherein said at least one of an additional switch, sensor, sensing element provides at least one signal with each rotation or part thereof of said assembly spinning about a central axis relative to said housing.

17. The device of claim 14 wherein at least one sound is synchronized with said at least one signal.

18. The device of claim 14 wherein said at least one pattern of illumination is synchronized with said at least one signal.

19. The device of claim 15 wherein said at least one sound is synchronized with said at least one pattern of illumination.

20. The device of claim 14 further comprising a communication device that receives data or signals via at least one of RF, IR, acoustically, or other methods such as for example the following: GPS, Wi-Fi, satellite, radio wave, Bluetooth, RFID, sonar, sonic, audio, vibration, light, sound, electronic, UHF, microwave, broad band modulation, amplitude modulation, frequency modulation, spread spectrum, and/or infrared.

21. The device of claim 18 wherein said data or signals controls said at least one pattern of illumination or at least one sound or said at least one pattern of illumination and said at least one sound. Also can control other functions such as vibration or others.

22. The device of claim 10 further comprises RFID technology or proximity sensing devices that will produce a proximity signal to indicate proximity to at least one object and location or object or location.

23. The device of claim 14 wherein at least one custom sound and at least one pattern of illumination or at least one custom sound or at least one pattern of illumination indicates proximity to at least one object and location or object or location.

24. The device of claim 9 wherein there is a projection device and a projection out of the bottom, top or side or any combination of bottom, top, and/or side of said base unit housing.

25. The device of claim 8 wherein said at least one of a logo, image, three dimensional or other object or shape is illuminated.

26. The device of claim 1 wherein at least one power source is at least one battery.

27. The device of claim 24 wherein said at least one battery is housed within at least one battery compartment.

28. The device claim 1 wherein at least one switch or button is comprised of at least one on/off switch.

29. The device claim 1 further comprising at least one of the following:
at least one locating and/or sensing mechanism;
at least one receiver;
at least one controller;
at least one transmitter;
at least one transmitter/receiver; and/or
a controlling and/or operating software application utilized to control or operate at least one of at least one receiver, at least one controller, at least one transmitter, and/or at least one transmitter and/or receiver.

30. The device of claim 27 wherein at least one of the at least one locating and/or sensing mechanism, at least one receiver, and/or at least one controller, at least one transmitter, and/or at least one transmitter/receiver can receive and/or transmit at least one of GPS, Wi-Fi, satellite, radio wave, Bluetooth, RFID, sonar, sonic, audio, vibration, light, sound, electronic, UHF, microwave, broad band modulation, amplitude modulation, frequency modulation, spread spectrum, and/or infrared.

31. The device of claim 27 wherein at least one of the at least one receiver, at least one transmitter and/or at least one transmitter/receiver is attached and/or connected to, and/or partially or wholly located within or inside the at least one locating and/or sensing mechanism and/or is the at least one locating and/or sensing mechanism.

32. The device of claim 27 wherein at least one of the at least one receiver, at least one transmitter and/or at least one transmitter/receiver is located within or is attached to the at least one controller.

33. The device of claim 27 wherein the at least one controller is at least one remote control.

34. The device of claim 27 wherein the at least one controller is at least one of a computer, input device, output device, tablet, smart phone, smart device, sound device, and/or a stationary, handheld, and/or mobile device.

35. The device of claim 31 wherein the at least one remote control further comprises at least one button or other signal controller that, when depressed, initiated, and/or activated, sends or receives at least one signal to or from at least one of the at least one receiver, at least one transmitter, and/or at least one transmitter/receiver located in the at least one remote control to at least one of the at least one receiver, at least one transmitter, and/or at least one transmitter/receiver located in the at least one locating and/or sensing mechanism.

36. The device of claim 27 wherein the at least one controlling and/or operating software application, when activated and/or instructed to, sends at least one signal from at least one of the at least one transmitter and/or at least one transmitter/receiver located in the at least one controller to at least one of the at least one locating and/or sensing mechanism and/or the at least one receiver and/or at least one transmitter/receiver located in/on the at least one locating and/or sensing mechanism.

37. The device of claim 1 further comprising a means for making noise and/or sound, audio, music, voice, songs, creating light and/or flashing lights, vibrating, and/or creating any other celebration display on and/or from said device.

38. The device of claim 1 further comprising at least one strap or other carrying device.

39. The device of claim 27 where the device is a remote controlled toy.

40. The device of claim 32 can be programmed to perform certain functions by inputting or entering instructions.

41. The device of claim 14 whereby at least one switch or button or sensor or sensing element r can be at least one of sensed by, connected to, activated by, deactivated by, and/or controlled by electronics.

42. The device of claim 39 whereby at least one switch and/or at least one sensor can be activated by at least one of motion, acceleration and/or impact.

43. The device of claim 1 further comprising electronics that are able to control the lighting of said at least one LED light in at least one lighting sequence.

44. The device of claim 39 whereby the activation of at least one switch and/or at least one sensor can initiate, activate, deactivate, control, operate, and/or run at least one lighting sequence.

45. The device of claim 41 whereby the lighting of the at least one lighting sequence can be at least one of repetitive or random.

46. The device of claim 41 whereby said lighting, circuitry and/or electronics can incorporate a dimming function as part of said at least one lighting sequence.

47. The device of claim 14 whereby at least one switch and/or at least one sensor can sense sound, vibration, acoustic energy and/or audio from the environment and convert such sound, vibration, acoustic energy and/or audio into a signal.

48. The device of claim 16 whereby at least one signal can be resolved into frequency, amplitude and/or a combination thereof.

49. The device of claim 46 whereby said frequency, amplitude and/or a combination thereof can control or affect the pattern and/or intensity of the LED lighting.

50. The device of claim 1 additionally comprising at least one of a connector and/or jack for connecting the device to an audio, power and/or other source.

51. The device of claim 1 further comprising a conductive connector or jack for connecting the device/invention to a mobile device, smart device, computer, electronic device, tablet, reader, mobile phone, and/or other device or signal source.

52. The device of claim 48 further comprising of at least one custom color and/or pattern, sound, audio, vibration, light, voice, music, song, or other recognition feature for identification for calls, e-mails, texts, and/or other origin-specific electronic communications, and/or at least one communication device that can transmit and/or receive data and/or signals in a master-slave fashion via radio frequency, infrared, and/or other communication methods.

53. The device of claim 49 further comprising of at least one custom color and/or pattern, sound, audio, vibration, light, voice, music, song, or other recognition feature for identification for calls, e-mails, texts, and/or other origin-specific electronic communications, and/or at least one communication device that can transmit and/or receive data and/or signals in a master-slave fashion via radio frequency, infrared, and/or other communication methods.

54. A customizable light-up device carry sales cart or push cart comprising of at least one of the following:
at least one carrying or push cart used to carry products for sale commonly found at theme parks, amusement parks, and other outdoor parks, places, tourist attractions, sports events, arenas, and events;
at least one power source;
at least one tray surface or at least two tray surfaces (bottom and top);
at least one display rack for toys or other products to be placed for marketing, demonstration, and sale;
at least one display rack designed for light-up toys or other products to be placed for marketing, demonstration, and sale;
at least one display rack designed for light-up toys or other products to be placed for marketing, demonstration, and sale with special holographic and reflective surface for better viewing of a light up toy such as the customizable light-up device;
at least one attaching device for display rack to cart;
at least one mounting and holding device or attachment to hold in place toys or products;
at least one remote control unit capable of controlling at least one toy or product for demonstration while such toy or product is displayed on the cart.
